(19) United States
(12) Patent Application Publication
(10) Pub. No.: US 2010/0199178 A1
(43) Pub. Date: Aug. 5, 2010

(54) SCREEN OUTPUT CONTROL DEVICE FOR MOBILE COMMUNICATION TERMINAL

(75) Inventors: Won-ho Lim, Seoul (KR); Sung-gyu Choi, Seoul (KR); Sang-min Lee, Hanam-si (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/546,413

(22) Filed: Aug. 24, 2009

(30) Foreign Application Priority Data
Jan. 30, 2009 (KR) 10-2009-0007459

(51) Int. Cl. G06F 3/01; G06F 3/048

(52) U.S. Cl. 715/702; 715/760

(57) ABSTRACT

A screen output control device of a mobile communication terminal includes a first screen output unit to output a first portion of a web page on a first screen, and a second screen output unit to output a second portion of the web page on a second screen. The first portion is a scaled down version of the web page, and the second portion is part of the first portion. The second portion may be enlarged relative to the first portion to be displayed in a scale that is more visible by a user. A user may navigate the web page through a user input to the first screen or the second screen. Another screen output control device divides a web page into areas, each of which is synchronized with inputs of an operation unit so that an area can be selected for display by entering the corresponding input.

### CROSS-REFERENCE TO RELATED APPLICATION

This application claims priority from and the benefit of Korean Patent Application No. 10-2009-7459, filed on Jan. 30, 2009, which is hereby incorporated by reference for all purposes as if fully set forth herein.

### BACKGROUND OF THE INVENTION

1. Field of the Invention

The following description relates to a screen output control device for a mobile communication terminal, and more particularly, to a screen output control device implementing a web page navigating technique for a mobile communication terminal.

2. Discussion of the Background

Mobile communication terminals have relatively small screens and thus may be limited in displaying large web pages. Because a user meticulously operates a cursor to navigate to a desired location on a web page, it is both very inconvenient and time-consuming.

### SUMMARY OF THE INVENTION

Exemplary embodiments of the present invention provide a screen output control device of a mobile communication terminal which can navigate a web page displayed on a screen of a mobile communication terminal to a location desired by a user.

Additional aspects of the invention will be set forth in the description which follows, and in part will be apparent from the description, or may be learned by practice of the invention.

An exemplary embodiment of the present invention discloses a screen output control device of a mobile communication terminal, including a first screen output unit to output a first portion of a web page on a first screen of the mobile communication terminal, and a second screen output unit to output a second portion of the web page on a second screen of the mobile communication terminal, the second portion including a portion of the first portion of the web page output on the first screen.

An exemplary embodiment of the present invention discloses a screen output control device of a mobile communication terminal, including a screen output unit to output a first area of a web page on a screen of a mobile communication terminal, and a screen output controller to navigate the web page output on the screen according to a user operation. Further, the web page is divided into a plurality of areas, each of which is respectively synchronized with one of a plurality of inputs of an operation unit, and the first area of the web page is output on the screen if the user operation is a first input corresponding to the first area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of a screen output control device of a mobile communication terminal according to an exemplary embodiment of the present invention.

FIG. 2 shows a screen output example of the screen output control device of FIG. 1.

FIG. 3 is a block diagram of a screen output control device of a mobile communication terminal according to an exemplary embodiment of the present invention.

FIG. 4 shows a screen output example of the screen output control device of FIG. 3.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

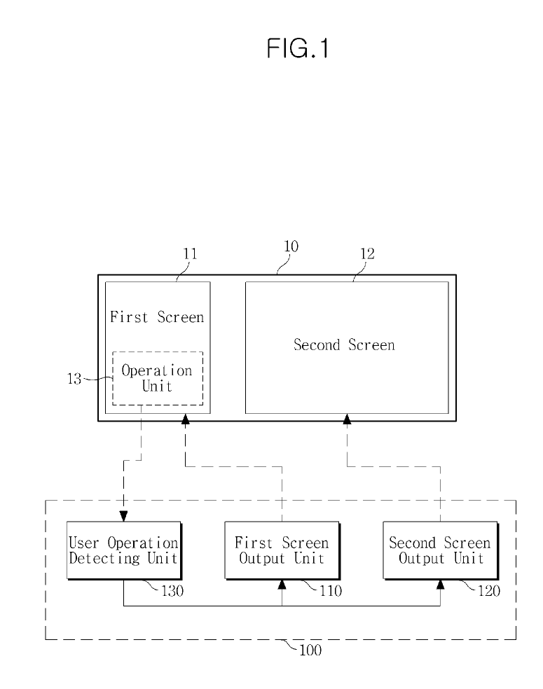

FIG. 1 is a block diagram of a screen output control device of a mobile communication terminal according to an exemplary embodiment of the present invention.

Referring to FIG. 1, a mobile communication terminal 10 includes a first screen 11, a second screen 12, and an operation unit 13 through which a user inputs an instruction. The first screen 11 and the second screen 12 may be separate liquid crystal displays (LCDs), and the operation unit 13 may be a touch screen to receive a user input through the first screen 11, the second screen 12, or both the first screen 11 and the second screen 12. Although the first screen 11 and the second screen 12 are shown as separate screens in FIG. 1, the first screen 11 and the second screen 12 may be divided portions of a single screen in the mobile communication terminal 10. In this instance, the relative portions of the single screen allocated to the first screen 11 and the second screen 12 may be fixed, or may be adjustable, such as by user settings or adaptive software. Additionally, if the first screen 11 and the second screen 12 are separate screens, they may be arranged on different portions of a mobile communication terminal 10. For example, if the mobile communication terminal 10 is a sliding-type terminal or a flip-type terminal, the first screen 11 may be on a first casing of the terminal, and the second screen 12 may be on a second casing of the terminal.

As shown in FIG. 1, a screen output control device 100 of the mobile communication terminal 10 may include a first screen output unit 110 and a second screen output unit 120.

The first screen output unit 110 outputs all or a part of a web page on the first screen 11 of the mobile communication terminal 10. For example, a screen displayed by the first screen output unit 110 may be a screen in which the whole web page is scaled down.

The second screen output unit 120 outputs a selected area of the web page output on the first screen 11 on the second screen 12.

Due to characteristics of the mobile communication terminal 10, a size of a screen output thereof is limited. Therefore, an entire web page generally cannot be displayed on the screen in format that a user can view easily. Therefore, while the first screen output unit 110 outputs all or a part of a web page on the first screen 11, only a part of the web page is displayed on the second screen 12 of the mobile communication terminal 10 through the second screen output unit 120.

Thus, to represent the area of the web page that is displayed on the second screen 12, a scaled-down image of the web page is generated through the first screen output unit 110 and displayed on the first screen 11. The web page displayed on the first screen 11 may be referred to as a scaled-down web page.

Then, the area of the web page displayed on the second screen 12 is indicated on the scaled-down web page displayed on the first screen 11. For example, the area of the web page output on the second screen may be indicated on the reduced web page output on the first screen 11 using a rectangular box, which may be highlighted or displayed in a color such as red that clearly indicates the area of the web page displayed on the second screen 12. Further, coordinates of the scaled-down web page are synchronized with corresponding areas of the entire web page.

The first screen output unit 110 or the second screen output unit 120 navigates the area of the web page output on the first screen 11 or the second screen 12 according to a user operation. For example, the user operation may be generated by selecting a certain area on the first or second screen or moving a display location from one location to another location on the first screen 11 or the second screen 12. The user operation may be detected by a user operation detector 130 which will be described later.

When navigating from a current area to a new area of the web page according to the user operation, the new area of the web page navigated to according to the user operation is displayed on the second screen 12 through the second output unit 120, and a location of the web page corresponding to the new area of the web page displayed on the second screen 12 is updated and indicated on the scaled-down web page output on the first screen 11.

Therefore, the screen output control device 100 of the mobile communication terminal 10 can navigate a part of the web page displayed on the first screen 11 of the mobile communication terminal 10 to a location of the web page desired by the user and thus display an area of the web page desired by the user on the second screen 12.

The screen output control device 100 of the mobile communication terminal may further include the user operation detector 130. The user operation detector 130 detects a user operation for navigating an area of the web page output on the first screen 11 or the second screen 12.

The user operation for navigating an area of the web page output on the first screen 11 or the second screen 12 may be generated according to a user input through the operation unit 13 of the mobile communication terminal 10. For example, the operation unit 13 may be a touch screen which receives the user input if the user touches the first screen 11 or the second screen 12.

For example, if the user selects a certain area of the scaled-down web page displayed on the first screen 11, the user operation detector 130 detects the user operation and outputs a signal corresponding to the selected certain area to the second screen output unit 120. The second screen output unit 120 displays an area of the web page corresponding to the selected area on the second screen 12.

Also, the first screen output unit 110 indicates a location corresponding to the new area of the web page displayed on the second screen 12 on the scaled-down web page output through the first screen 11. Accordingly, a display screen can be navigated to a location of the web page desired by the user, so that the area of the web page desired by the user can be more conveniently displayed using a simple operation.

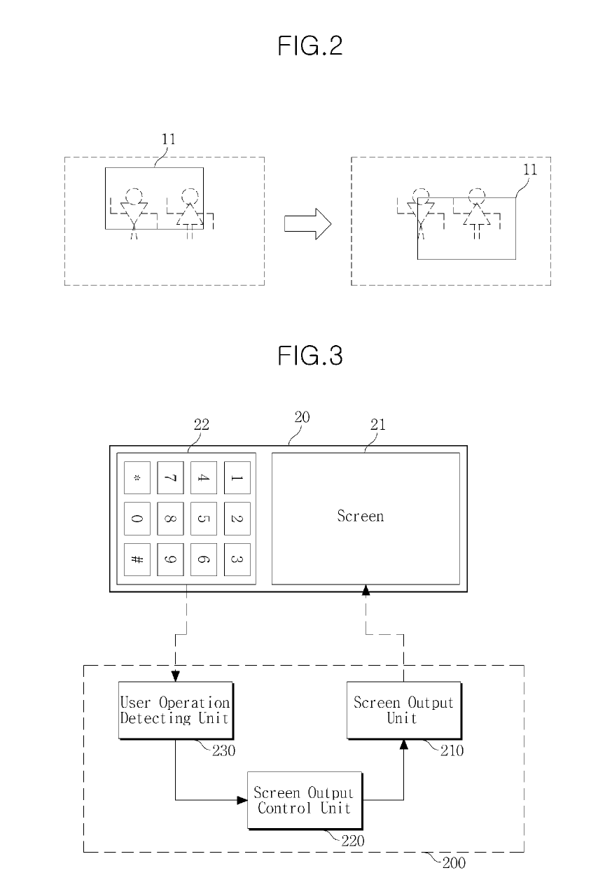

FIG. 2 shows a screen output example of the screen output control device of the mobile communication terminal of FIG. 1. Referring to FIG. 2, an area of a web page displayed on the second screen 12 before navigation and an area of the web page displayed on the second screen 12 after navigation. The navigation may be performed through a user input through the operation unit 13 of the mobile communication terminal 10. Specifically, the user may touch the first screen 11 to provide the user input and may drag the corners of, sides of, or entire rectangular box to navigate the rectangular box to the new area of the web page. Alternatively, the user may touch the first screen 11, and portion of the web page centered on the location of the touch may be displayed on the second screen 12. For example, as shown in FIG. 2, an area of the web page displayed on the second screen 12 can be navigated in a diagonal direction. Further, while the image shown in FIG. 2 has been described as a web page, the image could be a picture image, a document, a desktop, or another type of image able to be displayed on a mobile communication terminal.

FIG. 3 is a block diagram of a screen output control device of a mobile communication terminal according to an exemplary embodiment of the present invention. Referring to FIG. 3, a mobile communication terminal 20 has a screen 21, and a key pad is provided as the operation unit 22 for the user input.

As shown in FIG. 3, a screen output control device 200 of the mobile communication terminal includes a screen output unit 210 and a screen output control unit 220.

The screen output unit 210 outputs all or a part of a web page on the screen 21 of the mobile communication terminal 20. Due to characteristics of the mobile communication terminal, a size of a screen output thereof is limited.

Therefore, the entire web page generally cannot be displayed on the screen 21 in format that a user can easily view, and only a part of the web page may be displayed on the screen 21 of the mobile communication terminal 20 through the screen output unit 210.

The screen output control unit 220 navigates an area of the web page output on the screen 21 according to the user operation. The user operation of navigating the area of the web page output through the screen 21 may be generated according to the user input using the operation unit 22. For example, the operation unit 22 may be a numeric key pad or a full QWERTY-style keyboard. Further, the operation unit 22 may be implemented as individual buttons or as a touch screen displaying images of the keys to receive the user input. The user operation may be detected by a user operation detecting unit 230, which will be described later.

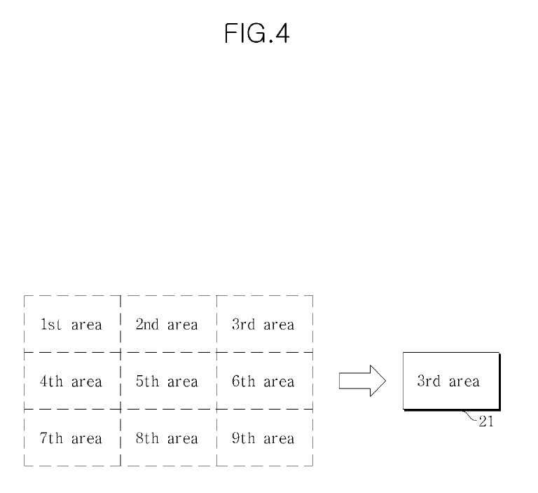

For example, as shown in FIG. 4, a web page may be divided into a plurality of areas, each of which is synchronized with one of the respective keys (e.g., digit keys) of the key pad. If the user presses a certain key, an area corresponding to the pressed key is displayed on the screen 21 through the screen output control unit 220. Accordingly, the area of the web page displayed on the screen 21 can be navigated to a desired area according to the user operation. FIG. 4 shows that a 3rd area, which may correspond to a digit key 3 on the key pad, is displayed on the screen 21.

Therefore, the screen output control device 200 of the mobile communication terminal 20 can navigate an area of the web page displayed on the screen 21 of the mobile communication terminal 20 to an area desired by the user by receiving a command on the operation unit 22.

The screen output control device 200 of the mobile communication terminal 20 may further include a user operation detecting unit 230. The user operation detecting unit 230 detects the user operation for navigating an area of the web page displayed on the screen 21.

For example, if the operation unit 22 is a key pad, the user operation detecting unit 230 may be a key matrix circuit for detecting a signal generated when a key is pressed. Alternatively, a web page may be divided into a plurality of areas, each of which is synchronized with one of the keys of the key pad, respectively. In this case, the user operation detecting unit 230 may detect a key selected by the user and output an area of the web page that corresponds to the selected key through the screen output controller 220.

As is apparent from the above description, an area of a web page displayed on a screen of a mobile communication terminal can be navigated to a location of the web page desired by a user.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A screen output control device of a mobile communication terminal, comprising:
a first screen output unit to output a first portion of a web page on a first screen of the mobile communication terminal; and
a second screen output unit to output a second portion of the web page on a second screen of the mobile communication terminal, the second portion comprising a portion of the first portion of the web page output on the first screen.

2. The screen output control device of claim 1, wherein the first screen output unit navigates an area of the web page displayed on the first screen according to a user operation.

3. The screen output control device of claim 1, wherein the second screen output unit navigates an area of the web page displayed on the second screen according to a user operation.

4. The screen output control device of claim 1, further comprising:
a user operation detector to detect a user operation for navigating an area of the web page output on the first screen or the second screen.

5. The screen output control device of claim 2, wherein the user operation for navigating an area of the web page output on the first screen is generated according to a user input through an operation unit of the mobile communication terminal.

6. The screen output control device of claim 5, wherein the operation unit is a touch screen to receive the user input if a user touches the first screen.

7. The screen output control device of claim 3, wherein the user operation for navigating an area of the web page output on the second screen is generated according to a user input through an operation unit of the mobile communication terminal.

8. The screen output control device of claim 7, wherein the operation unit is a touch screen to receive the user input if a user touches the second screen.

9. A screen output control device of a mobile communication terminal, comprising:
a screen output unit to output a first area of a web page on a screen of a mobile communication terminal; and
a screen output controller to navigate the web page output on the screen according to a user operation,
wherein the web page is divided into a plurality of areas, each of which is respectively synchronized with one of a plurality of inputs of an operation unit, and the first area of the web page is output on the screen if the user operation is a first input corresponding to the first area.

10. The screen output control device of claim 9, further comprising:
a user operation detector to detect the user operation for navigating the web page output on the screen.

11. The screen output control device of claim 10, wherein the user operation is generated according to a user input through the operation unit of the mobile communication terminal.

12. The screen output control device of claim 9, wherein the operation unit is a key pad.

13. The screen output control device of claim 9, wherein the operation unit is a QWERTY keyboard.

14. The screen output control device of claim 9, wherein the operation unit is a touch screen to receive the user input.
